(19) United States
(12) Patent Application Publication
(10) Pub. No.: US 2026/0085801 A1
(43) Pub. Date: Mar. 26, 2026

(54) LIGHT EMITTING DEVICE

(71) Applicant: TOYODA GOSEI CO., LTD., Kiyosu-shi (JP)

(72) Inventors: Yuki TANAKA, Aichi (JP); Tatsuya KOZAWA, Aichi (JP)

(21) Appl. No.: 19/302,243

(22) Filed: Aug. 18, 2025

(30) Foreign Application Priority Data
Sep. 25, 2024 (JP) 2024-166684

(51) Int. Cl. F21S 41/26; F21W 102/30; F21Y 115/10

(52) U.S. Cl. CPC F21S 41/26; F21W 2102/30; F21Y 2115/10

(57) ABSTRACT

A light emitting device includes a light source unit including a light source configured to output light, a housing to which the light source unit is attached, and a transparent outer lens attached to the housing and having a first reflection surface that is configured to reflect the light, which has been incident into the outer lens, in a direction intersecting an optical axis of the light source and a lens cut portion including plural second reflection surfaces configured to reflect the light, which has been reflected by the first reflection surface and has propagated inside the outer lens, toward a front surface of the outer lens facing the housing.

### CROSS-REFERENCE TO RELATED APPLICATION

This application is based on and claims priority under 35 USC 119 from Japanese Patent Application No. 2024-166684 filed on Sep. 25, 2024.

### TECHNICAL FIELD

The present invention relates to a light emitting device.

### BACKGROUND ART

As a conventional technique, there is known a lamp body for a vehicle including an outer housing formed of an opaque material, a power supply terminal disposed in the outer housing, a light source fixed in contact with the power supply terminal, and an outer lens formed of a transparent material (for example, see Patent Literature 1).

This lamp body for a vehicle further includes an inner lens between the outer housing and the outer lens, which guides light emitted from the light source to an end portion of the lamp body.

Patent Literature 1: JP2011-009112A

### SUMMARY OF INVENTION

Since the lamp body for a vehicle in the relate art includes the inner lens between the outer housing and the outer lens, the number of components is large, the cost is high, and it is difficult to reduce a thickness of the product.

Accordingly, an object of the present invention is to provide a light emitting device that can be made thinner.

An aspect of the present invention provides a light emitting device including a light source unit including a light source configured to output light, a housing to which the light source unit is attached, and an outer lens attached to the housing and having a first reflection surface that reflects incident light in a direction intersecting an optical axis of the light source and a lens cut portion including a plurality of second reflection surfaces that reflect the light reflected and propagating inside toward a front surface facing the housing.

According to the present invention, it is possible to make the vehicle thinner.

### BRIEF DESCRIPTION OF DRAWINGS

FIG. 1 is a view illustrating an example of a light emitting device according to an embodiment.

FIG. 2 is an enlarged view of a periphery of a first reflection surface of the light emitting device according to the embodiment.

FIG. 3 is a view illustrating an example of arrangement of the light emitting devices according to the embodiment.

### DESCRIPTION OF EMBODIMENTS

### Summary of Embodiment

A light emitting device according to an embodiment schematically includes a light source unit including a light source configured to output light, a housing to which the light source unit is attached, and an outer lens attached to the housing and having a first reflection surface that reflects incident light in a direction intersecting an optical axis of the light source and a lens cut portion including a plurality of second reflection surfaces that reflect the light reflected and propagating inside toward a front surface facing the housing.

Since the light emitting device includes the housing and the outer lens, the light emitting device can be made thinner as compared with a case where an inner lens is provided between the housing and the outer lens.

### Embodiment

### Outline of Light Emitting Device 1

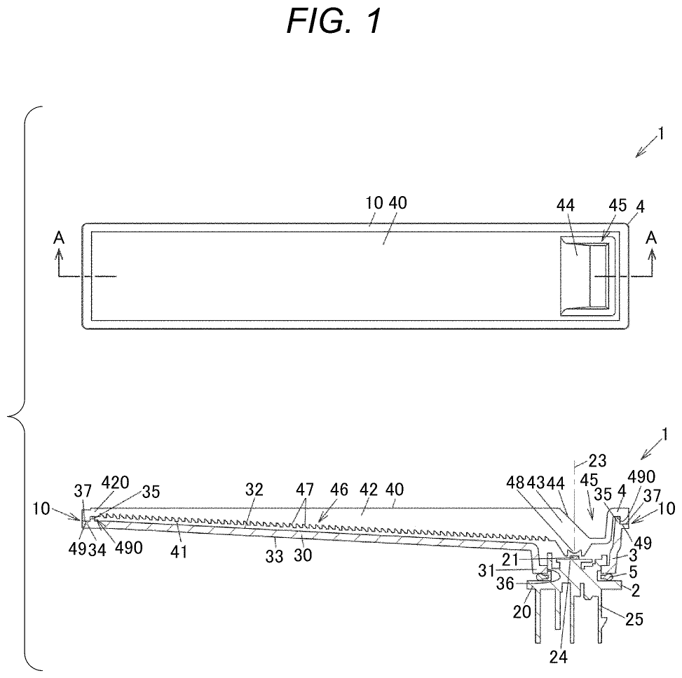

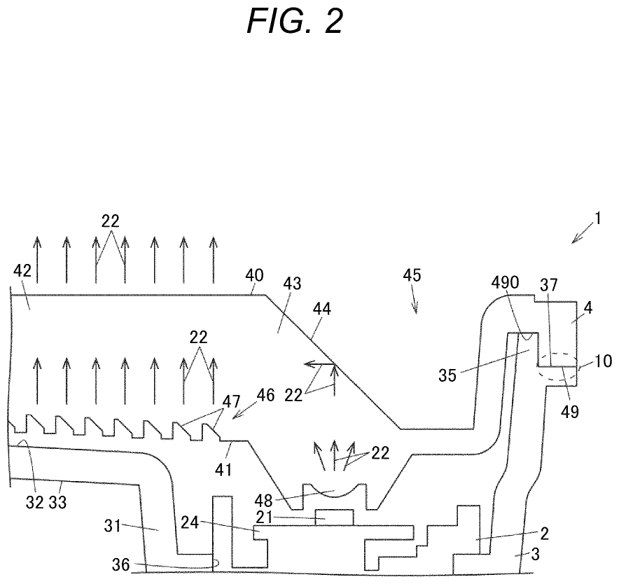

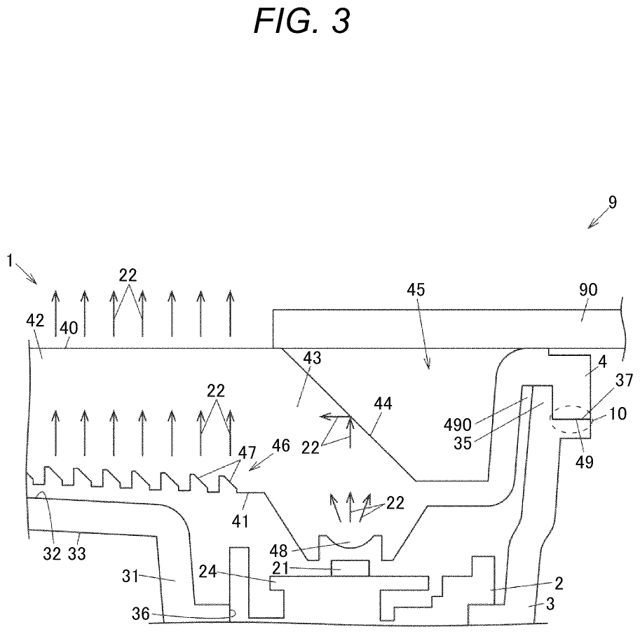

FIG. 1 is a view illustrating an example of a light emitting device according to an embodiment. FIG. 2 is an enlarged view of a periphery of a first reflection surface of the light emitting device according to the embodiment. FIG. 3 is a view illustrating an example of arrangement of the light emitting devices according to the embodiment. In FIG. 1, an upper part is an example of a top view of the light emitting device, and a lower part is an example of a cross-sectional view of the upper part taken along a line A-A as viewed from an arrow direction. In each of the drawings according to the embodiment described below, the ratio or shape between figures may be different from the actual ratio or shape. First, outline of a light emitting device 1 will be described below.

The light emitting device 1 is used as, for example, a fog lamp or a reverse light of a vehicle, but is not limited thereto.

As illustrated in FIGS. 1 and 2, the light emitting device 1 schematically includes a light source unit 2 including a light source 21 that outputs light 22, a housing 3 to which the light source unit 2 is attached, and an outer lens 4 that is attached to the housing 3 and has a first reflection surface 44 that reflects the incident light 22 in a direction intersecting an optical axis 23 of the light source 21 and a lens cut portion 46 including a plurality of second reflection surfaces 47 that reflect the light 22 reflected and propagating inside toward a front surface 40 facing the housing 3.

As illustrated in FIG. 2, the outer lens 4 includes a condenser lens 48 that condenses the light 22 output from the light source unit 2, the condenser lens 48 facing the light source 21.

As illustrated in FIG. 1, the housing 3 and the outer lens 4 have, at peripheral edges thereof, a welded region 10 that is welded to and integrated with each other. In FIGS. 2 and 3, as an example, an approximate range of the welded region 10 on the light source 21 side is surrounded by a dotted line.

As illustrated in FIG. 1, the outer lens 4 has an elongated shape, the light source unit 2 is disposed at one end portion 43, and a thickness thereof decreases as a distance from the light source unit 2 increases.

The housing 3 has a convex portion 35 for positioning with the outer lens 4.

### Configuration of Light Source Unit 2

As illustrated in FIG. 1, the light source unit 2 schematically includes a main body 20 and the light source 21. The main body 20 includes a substrate 24 on which the light source 21 is disposed, and a connector portion 25 to which a connector of a harness of the vehicle is electrically connected.

The light source 21 is, for example, a light emitting element such as a light emitting diode (LED) element. The light source 21 may be configured to output, for example, white light 22, but may be configured to output another color depending on the application. The light source unit 2 is not limited to one light source 21, and may include a plurality of light sources 21.

### Configuration of Housing 3

The housing 3 is formed of, for example, a resin material such as polycarbonate or acrylic. As illustrated in FIG. 1, the housing 3 includes a housing main body 30 and an attachment portion 31 provided at an end portion of the housing main body 30 opposite to a distal end portion 34.

The housing main body 30 has an elongated shape. For example, when the light emitting device 1 is used as a backlight, a front surface 32 of the housing main body 30 is white. The distal end portion 34 of the housing main body 30 is an end portion farthest from the light source unit 2. The housing main body 30 has the convex portion 35 protruding from the front surface 32 from the distal end portion 34 to the attachment portion 31, that is, around a peripheral edge of the front surface 32. The front surface 32 of the housing 3 may be white, or the resin material may be clouded.

The convex portion 35 on the attachment portion 31 side is positioned by being fitted into a fitting portion 490 of the outer lens 4. As illustrated in FIG. 1, the fitting portion 490 on the end portion 43 side has a concave shape, and the fitting portion 490 in other portions has a stepped shape.

The attachment portion 31 is provided so as to protrude from a back surface 33 of the housing main body 30, and has an opening 36 to which the light source unit 2 is attached. The light source unit 2 is inserted into the opening 36 via an elastic body 5 and integrated with the housing 3. The elastic body 5 is, for example, an O-ring formed using a synthetic rubber material, but is not limited thereto.

### Configuration of Outer Lens 4

The outer lens 4 is formed using, for example, a transparent resin material such as polycarbonate or acrylic. The outer lens 4 includes a lens main body 42 and the end portion 43.

As illustrated in FIG. 1, the lens main body 42 has the lens cut portion 46 on a back surface 41 side. As illustrated in FIG. 2, the lens cut portion 46 is a plurality of recesses formed in the back surface 41, and the recesses form the plurality of second reflection surfaces 47 facing the first reflection surface 44 of the end portion 43.

The end portion 43 has the first reflection surface 44 and the condenser lens 48. As illustrated in FIG. 1, the first reflection surface 44 is formed as an inclined surface of a concave portion 45 provided on the front surface 40 of the end portion 43. The condenser lens 48 is a lens that condenses the light 22 output from the light source unit 2 and guides the light 22 to the first reflection surface 44.

The first reflection surface 44 and the second reflection surface 47 face each other and are parallel to each other. The first reflection surface 44 and the second reflection surface 47 have a total internal reflection (TIR) shape. Therefore, the first reflection surface 44 and the second reflection surface 47 totally reflect the incident light 22. The light 22 travels in a direction intersecting the optical axis 23 of the light source 21 by being totally reflected.

As illustrated in FIG. 1, the first reflection surface 44 is provided above the light source unit 2. The light 22 is emitted from the light source unit 2, condensed by the condenser lens 48, and totally reflected by the first reflection surface 44. The totally reflected light 22 propagates inside the lens main body 42, is totally reflected by the plurality of second reflection surfaces 47 of the lens cut portion 46, and is emitted from the front surface 40 to the outside of the outer lens 4.

For example, in the upper drawing of FIG. 1, each of the plurality of second reflection surfaces 47 is formed to be long in a vertical direction, but is not limited thereto, and may be formed in a dot shape.

As illustrated in FIG. 1, the thickness of the lens main body 42 decreases from the end portion 43 toward a distal end portion 420, but the thickness is not limited thereto, and may be the same.

The housing 3 and the outer lens 4 have a welding surface 37 and a welding surface 49 at peripheral edges thereof. The welding surface 37 and the welding surface 49 are surfaces welded by, for example, ultrasonic welding, hot plate welding, laser welding, or the like. As illustrated in FIG. 1, the welded region 10 formed by this welding is a peripheral edge of the front surface 40 of the outer lens 4. As a modification, the housing 3 and the outer lens 4 may be integrated by adhesion.

### Arrangement of Light Emitting Device 1

As illustrated in FIG. 3, the outer lens 4 is disposed to overlap a part of a vehicle 9 so that the concave portion 45 is not exposed to the outside. The part of the vehicle 9 is, for example, a spoiler 90. The spoiler 90 may be a garnish or the like that decorates the vehicle 9.

### Effects of Embodiment

The light emitting device 1 according to the present embodiment can be made thinner. Specifically, since the light emitting device 1 includes the housing 3 and the outer lens 4, the light emitting device 1 can be made thinner as compared with a case where an inner lens is provided between the housing and the outer lens. In addition, the number of components of the light emitting device 1 is smaller than that of a light emitting device including an inner lens, and the cost can be reduced.

In the light emitting device 1, even when the light source 21 is disposed not at a center but at the one end portion 43, the first reflection surface 44 and the second reflection surface 47 have a total reflection shape, and the light 22 is emitted directly to the outside from the outer lens 4, and therefore, compared to a case where this configuration is not adopted, it is possible to prevent unevenness in brightness and to make the entire light brighter.

In the light emitting device 1, since the housing 3 and the outer lens 4 are integrated by welding, the light emitting device 1 can be made thinner as compared with the case where the housing 3 and the outer lens 4 are integrated by screws or the like.

In the light emitting device 1, since the housing 3 has the convex portion 35 and the outer lens 4 has the fitting portion 490, the convex portion 35 and the fitting portion 490 can be fitted to each other to easily position the housing 3 and the outer lens 4 as compared with a case where this configuration is not adopted.

Since the light emitting device 1 is disposed so as to overlap a part of the vehicle 9 so that the concave portion 45 forming the first reflection surface 44 is not exposed to the outside, it is possible to prevent the intrusion of liquid, dust, or the like into the concave portion 45 and to prevent a decrease in performance caused by accumulation of liquid, dust, or the like in the concave portion 45, as compared with a case where this configuration is not adopted.

Although the embodiment and the modified example of the present invention have been described above, these embodiment and modified example are merely examples and do not limit the present invention according to the claims. These novel embodiment and modified example can be implemented in various other forms, and various omissions, replacements, changes, and the like can be made without departing from the gist of the present invention. In addition, all combinations of features described in the embodiment and the modified example are not necessarily essential for the means for achieving the object of the invention. The accompanying claims and their equivalents are intended to cover the embodiment and the modified example as would fall within the scope and spirit of the invention.

### REFERENCE SIGNS LIST

1 light emitting device
2 light source unit
3 housing
4 outer lens
5 elastic body
9 vehicle
10 welded region
20 main body
21 light source
22 light
23 optical axis
24 substrate
25 connector portion
30 housing main body
31 attachment portion
32 front surface
33 back surface
34 distal end portion
35 convex portion
36 opening
37 welding surface
40 front surface
41 back surface
42 lens main body
43 end portion
44 first reflection surface
45 concave portion
46 lens cut portion
47 second reflection surface
48 condenser lens
49 welding surface
90 spoiler
420 distal end portion
490 fitting portion

What is claimed is:

1. A light emitting device comprising:
a light source unit including a light source configured to output light;
a housing to which the light source unit is attached; and
a transparent outer lens attached to the housing and having a first reflection surface that is configured to reflect the light, which has been incident into the outer lens, in a direction intersecting an optical axis of the light source and a lens cut portion including a plurality of second reflection surfaces that is configured to reflect the light, which has been reflected by the first reflection surface and has propagated inside the outer lens, toward a front surface of the outer lens facing the housing.

2. The light emitting device according to claim 1, wherein
the outer lens comprises a condenser lens that is configured to condense the light output from the light source unit, the condenser lens facing the light source.

3. The light emitting device according to claim 2, wherein
the housing and the outer lens have, at peripheral edges thereof, a welded region in which a part of the housing and a part of the outer lens are welded to and integrated with each other.

4. The light emitting device according to claim 3, wherein
the outer lens has an elongated shape, the light source unit is disposed at one end portion of the outer lens, and a thickness of the outer lens decreases as a distance from the light source unit increases.

5. The light emitting device according to claim 4, wherein the housing has a convex portion for positioning with the outer lens.

6. The light emitting device according to claim 1, wherein
the outer lens has a concave portion forming the first reflection surface, and is to be disposed to overlap a part of a vehicle so that the concave portion is not exposed to outside.

7. The light emitting device according to claim 2, wherein
the outer lens has a concave portion forming the first reflection surface, and is to be disposed to overlap a part of a vehicle so that the concave portion is not exposed to outside.

8. The light emitting device according to claim 3, wherein
the outer lens has a concave portion forming the first reflection surface, and is to be disposed to overlap a part of a vehicle so that the concave portion is not exposed to outside.

9. The light emitting device according to claim 4, wherein
the outer lens has a concave portion forming the first reflection surface, and is to be disposed to overlap a part of a vehicle so that the concave portion is not exposed to outside.

10. The light emitting device according to claim 5, wherein
the outer lens has a concave portion forming the first reflection surface, and is to be disposed to overlap a part of a vehicle so that the concave portion is not exposed to outside.
